(19) United States
(12) Patent Application Publication
(10) Pub. No.: US 2005/0253698 A1
(43) Pub. Date: Nov. 17, 2005

(54) Smart network using a resistive system of identification of nodes

(75) Inventors: Stephane Talaucher, Bonnelles (FR); Bertrand Puzenat, Montigny Le Bretonneux (FR); Karen Chauvin, Domont (FR); Daniel Virey, Les Essarts Le Roi (FR); Paul Laurenceau, Viroflay (FR)

Correspondence Address: Valeo Climate Control Corp.;Intellectual Property Department, 4100 North Atlantic Boulevard, Auburn Hills, MI, 48326, US

(73) Assignee: Valeo Climatisation S.A., Le Mesnil Saint Denis (FR)

(21) Appl. No.: 11/125,967

(22) Filed: May 10, 2005

(30) Foreign Application Priority Data
May 14, 2004 (FR) 04 05323

(51) Int. Cl. B60Q 1/00

(52) U.S. Cl. 340/449

(57) ABSTRACT

Smart network comprising at least one peripheral (10₁, 10₂, . . . , 10ₙ) connected to a node (N₁, N₂, . . . , Nₙ) of said network, said node being identified by means of a resistive system (130; 130a, 130b) connected to a common conductor (14, 16, 18) of the smart network.

According to the invention, said resistive system comprises a resistive element (130; 130a) integrated with said common conductor, the peripheral being arranged in parallel with said integrated resistive element. Application to air conditioning installations in motor vehicles.

The present invention relates to a smart network using a resistive system of identification of nodes.

The invention finds a particularly advantageous but nonlimiting application in the field of air conditioning installations in motor vehicles, and more especially in that of the assigning of addresses to peripherals connected to the nodes of a smart network.

### BACKGROUND OF THE INVENTION

International Patent Application PCT/FR02/00676 describes, in a vehicle air conditioning installation for example, a smart network linked to a central control unit and to a plurality of peripherals linked to nodes of the network, the peripherals being connected in series via a common conductor of the smart network.

Within the framework of the air conditioning of vehicles, the peripherals may be actuators for distributing or mixing air, heater units or else temperature sensors. These various items of equipment are linked to the central control unit so as to receive control information and/or to send it state information.

It is in order to provide an identification of the nodes of the smart network making it possible to avoid permanent differentiation between peripherals of one and the same type, that the aforesaid international patent application proposes a method which consists, at the level of each peripheral, in injecting, for example, an electric current onto the common conductor of the network and in detecting by means of a resistive system connected to the common conductor, a shunt in particular an electrical signal depending on the electric currents injected by the peripherals situated upstream.

Means are then provided for generating, from the current detected, an information item regarding position relative to the peripheral and for identifying the node of the network to which it is connected from the relative position information item thus generated. The identification of the node of the smart network allows the assigning of an address or a check of the layout of the peripheral, from the central control unit.

However, though they offer numerous advantages in terms of identification of nodes, the smart networks constructed on the recommendations prescribed in the abovementioned international patent application have the drawback of being sensitive to the disconnection or the absence of connection of a peripheral on a given node of the smart network.

Specifically, in the case of the absence of a peripheral or if a peripheral is poorly connected to the common conductor, all the peripherals situated at connection nodes downstream of the failed or absent peripheral become disconnected from the smart network and, therefore:
can no longer communicate with the network control unit, if the resistive system is placed on the information bus in the guise of common conductor. On the other hand, the disconnected peripherals will still be powered and will therefore be able to enter a safety mode.
are no longer powered, if the resistive system is placed on one of the power supply conductors (earth or live point) in the guise of common conductor. No peripheral situated downstream is operational and cannot therefore place itself in safety position.

### SUMMARY OF THE INVENTION

Hence, the technical problem to be solved by the subject of the present invention is to propose a smart network comprising at least one peripheral connected to a node of said network, said node being identified by means of a resistive system connected to a common conductor of the smart network, which would make it possible to ensure the continuity of the functions of the network even if a peripheral is disconnected or poorly connected to the corresponding node.

The solution to the technical problem posed consists, according to the present invention, in said resistive system comprising a resistive element integrated with said common conductor, the peripheral being arranged in parallel with said integrated resistive element.

Thus, it is understood that the presence of said resistive element integrated with the common conductor makes it possible to obtain electrical continuity between the upstream and the downstream of the node corresponding to the missing or poorly connected peripheral. In particular, the peripherals situated downstream of this failed peripheral will be able to continue to be powered or receive the information flowing around the information bus.

An essential advantage of the invention consisting in the fact that the specification of identification of the nodes remains unchanged will also be noted.

According to a first embodiment of the invention, said resistive system comprises a single resistive element.

According to a second embodiment of the invention, said resistive system furthermore comprises a second resistive element integrated with said peripheral, arranged in parallel with the resistive element integrated with the common conductor.

The description which follows in conjunction with the appended drawings, given by way of nonlimiting examples, will elucidate the subject matter of the invention and the manner in which it may be embodied.

### BRIEF DESCRIPTION OF THE DRAWINGS

FIG. 1 is a diagram of a first embodiment of a smart network in accordance with the invention.

FIG. 2 is a diagram of a second embodiment of a smart network in accordance with the invention.

FIG. 3 is a variant embodiment of the diagram of FIG. 1.

FIG. 4 is a variant embodiment of the diagram of FIG. 2.

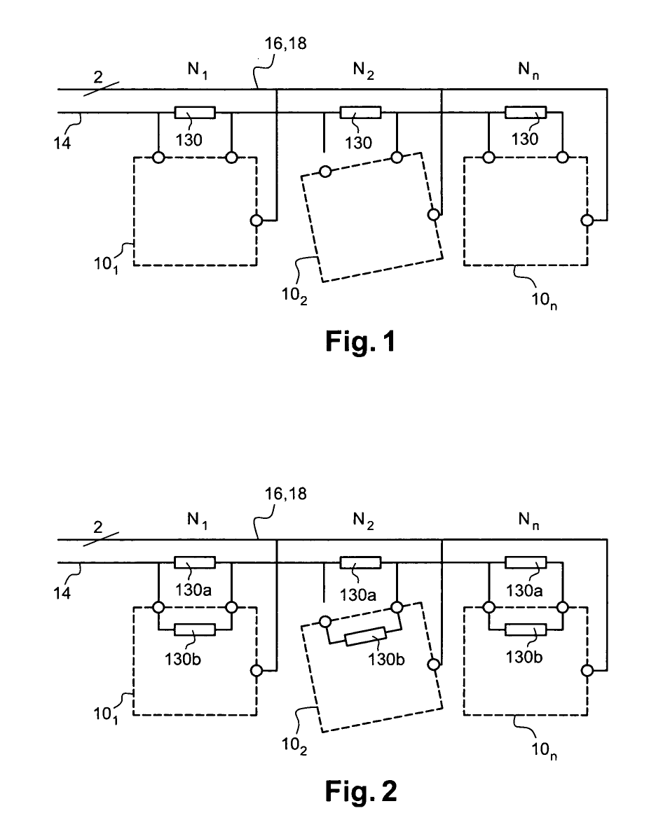

Represented in FIG. 1 is a smart network, such as an air conditioning installation of a motor vehicle, comprising a plurality of peripherals 10₁, 10₂, . . . , 10ₙ connected respectively to nodes N₁, N₂, . . . , Nₙ of the network.

Each peripheral is linked to electric power supply conductors 16, 18 (earth, live point) which, in the example of FIG. 1, are represented merged. The information flowing between the peripherals 10₁, 10₂, . . . 10ₙ and a control unit, not represented, is transported by an information bus 14 of the smart network.

The nodes N₁, N₂, . . . , Nₙ are identified in accordance with the method described in the international patent application PCT/FR02/00676 and the only reference to which we shall make here is that for each peripheral it implements a resistive system connected to a common conductor of the network.

### DESCRIPTION OF THE PREFERRED EMBODIMENTS

In the embodiment of FIG. 1, said common conductor is constituted by the information bus 14 and the resistive network comprises a single resistive element 130 integrated with the bus 14 at each node of the network and not at the corresponding peripheral as in the aforesaid international patent application. The resistive element 130 may be a shunt similar to that described in this same international patent application. In a practical manner, this shunt is embodied for example by means of a CMS resistor or a tapping resistor of small value and high precision.

It emerges from the configuration shown in FIG. 1 that in the case of a poor connection of a peripheral, for example, the peripheral 10₂ to the node N₂, to one of the connections of the resistive element 130, no break in communication can occur in respect of the peripherals situated downstream, such as the peripheral 10ₙ. The same holds if the peripheral 10₂ is not connected to the smart network.

The embodiment of FIG. 2 differs from that of FIG. 1 in that in addition to the resistive element 130a integrated with the common conductor 14, the resistive system of each peripheral 10₁, 10₂, . . . , 10ₙ, also comprises a second resistive element 130b integrated with each peripheral and arranged in parallel with the first resistive element 130a.

In this particular embodiment, the first resistive element 130a is said to be secure, while the first 130b is said to be functional.

It is understood that, in a manner similar to that of FIG. 1, the embodiment of FIG. 2 ensures, in the case of a poor connection of the peripheral 10₂ for example, the continuity of the transmission of information, via the safety element 130a, to the downstream peripherals such as the peripheral 10ₙ. The same also holds if the peripheral 10₂ is not connected to the smart network.

On the other hand, the network of FIG. 2 has the advantage as compared with that of FIG. 1 of avoiding any break in communication in case of disconnection of the safety element 130a itself, the continuity of transmission of the information then being ensured by the functional resistive element 130b.

So that the identification of the nodes N₁, N₂, . . . , Nₙ depends only on the value of the functional resistive element 130b of the peripherals 10₁, 10₂, . . . , 10ₙ, provision may be made for the safety resistive element 130a to have a value substantially greater than that of the functional element 130b.

In this case, the precision in the value of the safety element 130a is not a determining factor, thereby making it possible to envisage a wide range of technological solutions for the embodiment of this element. In particular, the safety element 130a may be a tapping resistor crimped at one end with the incoming conductor and at the other end with the outgoing conductor. Other embodiments are also possible such as a resistor consisting of a calibrated length of a poorly conducting material.

This latter advantage makes the embodiment of FIG. 2 a cheaper solution than that proposed in FIG. 1.

Specifically, the embodiment with safety element does not make it necessary to know the resistance of this element with great precision, in contradistinction to the functional element. Conversely, the embodiment with a single resistive element in the network is more complex to implement since in this case high precision must be obtained for a resistive element which is not in a peripheral but in the network.

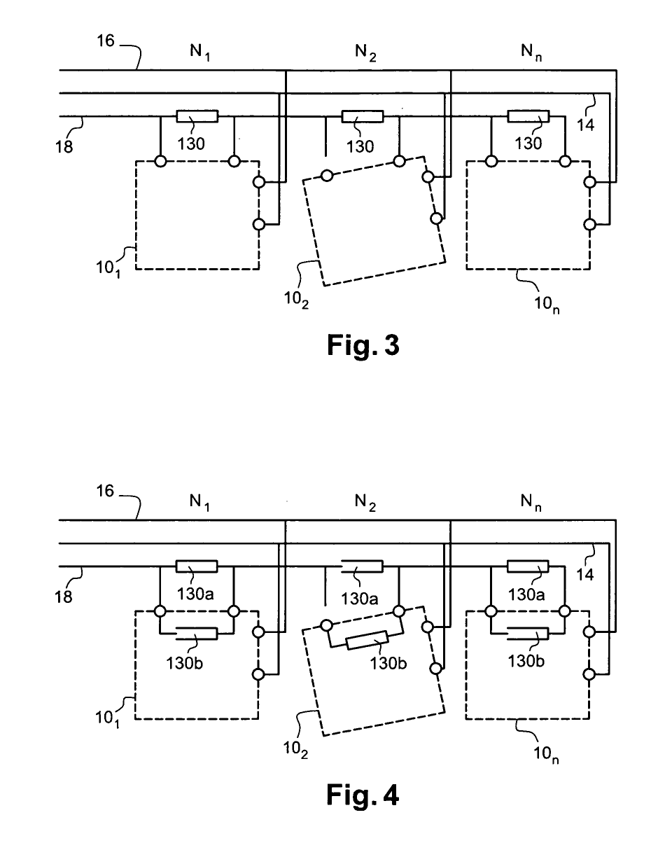

FIGS. 3 and 4 are respective variant embodiments of FIGS. 1 and 2 in which said common conductor is a power supply conductor, here the conductor 18.

It may be seen in FIGS. 3 and 4 that in the case of poor connection of the peripheral 10₂ to the conductor 18, the peripherals downstream, such as the peripheral 10ₙ remain powered, this being a necessary condition for entry into safety mode in the case of loss of communication. The same holds if the peripheral 10₂ is not connected to the smart network.

The advantage of the embodiment of FIG. 4 as compared with that of FIG. 3 is to avoid any loss of communication in case of breakage of the safety resistive element 130a, the information then being able to flow via the resistive element 130b integrated with the peripheral.

1. Smart network comprising at least one peripheral (10₁, 10₂, . . . , 10ₙ) connected to a node (N₁, N₂, . . . , Nₙ) of said network, said node being identified by means of a resistive system (130; 130a, 130b) connected to a common conductor (14, 16, 18) of the smart network, characterized in that said resistive system comprises a resistive element (130; 130a) integrated with said common conductor, the peripheral being arranged in parallel with said integrated resistive element.

2. System according to claim 1, characterized in that said resistive system comprises a single resistive element (130).

3. System according to claim 1, characterized in that said resistive system furthermore comprises a second resistive element (130b) integrated with said peripheral, arranged in parallel with the resistive element (130a) integrated with the common conductor.

4. System according to claim 3, characterized in that the resistive element (130a) integrated with the common conductor has a value substantially greater than the value of the second resistive element (130b).

5. System according to any one of claims 1 to 4, characterized in that said common conductor is a conductor (14) of an information bus of the smart network.

6. System according to any one of claims 1 to 4, characterized in that said common conductor is a power supply conductor (16, 18) of said peripheral.
